(19) United States
(12) Patent Application Publication
(10) Pub. No.: US 2025/0234266 A1
(43) Pub. Date: Jul. 17, 2025

(54) METHOD AND APPARATUS FOR LINK ESTABLISHMENT IN WIRELESS LAN SUPPORTING EMLSR

(71) Applicant: ELECTRONICS AND TELECOMMUNICATIONS RESEARCH INSTITUTE, Daejeon (KR)

(72) Inventors: Sung Hyun HWANG, Daejeon (KR); Kyu Min KANG, Daejeon (KR); Jae Cheol PARK, Daejeon (KR); Yong Ho KIM, Incheon (KR)

(21) Appl. No.: 18/698,347

(22) PCT Filed: Oct. 28, 2022
(86) PCT No.: PCT/KR2022/016751

§ 371 Date: Apr. 3, 2024

(30) Foreign Application Priority Data
Oct. 29, 2021 (KR) 10-2021-0147052

(51) Int. Cl. H04W 40/02; H04W 74/0816; H04W 84/12

(52) U.S. Cl. CPC H04W 40/02; H04W 74/0816; H04W 84/12

(57) ABSTRACT

A method and an apparatus for link establishment in a wireless LAN supporting EMLSR are disclosed. The method by a first device comprises the steps of: performing an operation of establishing a simultaneous reception standby link with a second device; when a first link and a second link are configured as the simultaneous reception standby link, performing a reception standby operation on the first link and the second link at the same time; receiving a control frame from the second device on the first link from among the first link and the second link; and receiving a data frame from the second device on the first link where the control frame was received.

### TECHNICAL FIELD

The present disclosure relates to a wireless local area network (LAN) communication technique, and more particularly, to a technique for link (re) configuration for enhanced multi-link signal radio (EMLSR) operations.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since a multi-link operation is an operation not defined in the existing wireless LAN standard, it may be necessary to define detailed operations according to an environment in which the multi-link operation is performed. In particular, a device (e.g., station (STA)) supporting enhanced multi-link single radio (EMLSR) operations may wait for reception in a multi-link. The device supporting EMLSR operations may be referred to as an EMLSR device. When a frame transmission/reception operation starts, the EMLSR device may operate in a single link where the frame transmission/reception operation is performed. While the frame transmission/reception operation is performed in a single link, other links may be in a state in which frame transmission and reception operations cannot be performed. A time may be required for transitioning a transceiver between links in the EMLSR device. Therefore, a frame transmission/reception method considering the operating characteristics of the EMLSR device in a single link may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for link (re) configuration in a wireless LAN supporting enhanced multi-link signal radio (EMLSR) operations.

### Technical Solution

A method of a first device, according to a first exemplary embodiment of the present disclosure for achieving the above-described objective, may comprise: performing a configuration operation of simultaneous reception standby links with a second device; when a first link and a second link are configured as the simultaneous reception standby links, simultaneously performing reception standby operations in the first link and the second link; receiving a control frame from the second device in the first link among the first link and the second link; and receiving a data frame from the second device in the first link where the control frame is received.

The performing of the configuration operation may comprise: transmitting, to the second device, a first frame including a bitmap indicating the simultaneous reception standby links; and receiving a second frame including the bitmap from the second device.

The method may further comprise, before performing the configuration operation, performing a traffic identifier (TID)-to-link mapping operation with the second device, wherein the first frame received in the first link has a first TID mapped to the first link.

A TID-to-link remapping operation may be performed in the configuration operation, or a default link mapping may be configured in the configuration operation.

The first frame may be indicated to be transmittable and receivable in the first link by the TID-to-link remapping operation or the default link mapping.

The control frame may be a multi-user (MU)-request to send (RTS) frame, a clear to send (CTS) frame, which is a response frame to the MU-RTS frame, may be transmitted to the second device, and the data frame may be received after transmission of the CTS frame.

The data frame may include reconfiguration information of the simultaneous reception standby links, and simultaneous reception standby links indicated by the reconfiguration information may be different from the simultaneous reception standby links according to the configuration operation.

The method may further comprise: transmitting, to the second device and in the first link, a reception response frame for the data frame; and performing a reception standby operation simultaneously in the simultaneous reception standby links indicated by the reconfiguration information after transmission of the reception response frame.

A method of a second device, according to a second exemplary embodiment of the present disclosure for achieving the above-described objective, may comprise: performing a configuration operation of simultaneous reception standby links with a first device; transmitting a control frame to the first device in the first link among the first link and the second link configured as the simultaneous receptions standby links; and transmitting a data frame to the first device in the first link where the control frame is transmitted, wherein a simultaneous reception standby operation of the first device is simultaneously performed in the simultaneous reception standby links.

The performing of the configuration operation may comprise: transmitting, to the first device, a first frame including a bitmap indicating the simultaneous reception standby links; and receiving a second frame including the bitmap from the first device.

The method may further comprise, before performing the configuration operation, performing a traffic identifier (TID)-to-link mapping operation with the first device, wherein the first frame transmitted in the first link has a first TID mapped to the first link.

A TID-to-link remapping operation may be performed in the configuration operation, or a default link mapping may be configured in the configuration operation.

The first frame may be indicated to be transmittable and receivable in the first link by the TID-to-link remapping operation or the default link mapping.

The data frame may include reconfiguration information of the simultaneous reception standby links, and simultaneous reception standby links indicated by the reconfiguration information may be different from the simultaneous reception standby links according to the configuration operation.

After receiving the reception response frame for the data frame, the reception standby operation of the first device may be simultaneously performed in the simultaneous reception standby links indicated by the reconfiguration information.

A first device, according to a third exemplary embodiment of the present disclosure for achieving the above-described objective, may comprise a processor, wherein the processor may cause the first device to perform: performing a configuration operation of simultaneous reception standby links with a second device; when a first link and a second link are configured as the simultaneous reception standby links, simultaneously performing reception standby operations in the first link and the second link; receiving a control frame from the second device in the first link among the first link and the second link; and receiving a data frame from the second device in the first link where the control frame is received.

In the performing of the configuration operation, the processor may further cause the first device to perform: transmitting, to the first device, a first frame including a bitmap indicating the simultaneous reception standby links; and receiving a second frame including the bitmap from the first device.

The processor may further cause the first device to perform: performing a traffic identifier (TID)-to-link mapping operation with the second device before performing the configuration operation, wherein the first frame received in the first link has a first TID mapped to the first link.

A TID-to-link remapping operation may be performed in the configuration operation, or a default link mapping may be configured in the configuration operation, and the first frame may be indicated to be transmittable and receivable in the first link by the TID-to-link remapping operation or the default link mapping.

The processor may further cause the first device to perform: transmitting, to the second device and in the first link, a reception response frame for the data frame; and performing a reception standby operation simultaneously in simultaneous reception standby links indicated by reconfiguration information of the simultaneous reception standby links after transmission of the reception response frame, the reconfiguration information being included in the data frame, wherein the simultaneous reception standby links indicated by the reconfiguration information are different from the simultaneous reception standby link according to the configuration operation.

### Advantageous Effects

According to the present disclosure, an enhanced multi-link single radio (EMLSR) device may wait for frame reception in links corresponding to the number of antennas. When a frame is received in a first link among the links, the EMLSR device may switch a radio chain to the first link and quickly receive a frame through a plurality of spatial streams. The EMLSR device (e.g., station (STA)) may configure a link to operate in the same link as an access point (AP). The links may be re-configured according to the type of transmitted data and/or the urgency of communication. Accordingly, data can be transmitted and received without communication interruption.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6 is a block diagram illustrating a first exemplary embodiment of an enhanced multi-link single radio (EMLSR) device in a wireless LAN.

FIG. 7 is a timing diagram illustrating a first exemplary embodiment of a communication method in a device supporting an EMLSR mode.

FIG. 8 is a timing diagram illustrating a second exemplary embodiment of a communication method in a device supporting an EMLSR mode.

FIG. 9 is a timing diagram illustrating a third exemplary embodiment of a communication method in a device supporting an EMLSR mode.

FIG. 10 is a timing diagram illustrating a fourth exemplary embodiment of a communication method in a device supporting an EMLSR mode.

FIG. 11 is a timing diagram illustrating a fifth exemplary embodiment of a communication method in a device supporting an EMLSR mode.

FIG. 12 is a timing diagram illustrating a sixth exemplary embodiment of a communication method in a device supporting an EMLSR mode.

### MODE OF INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

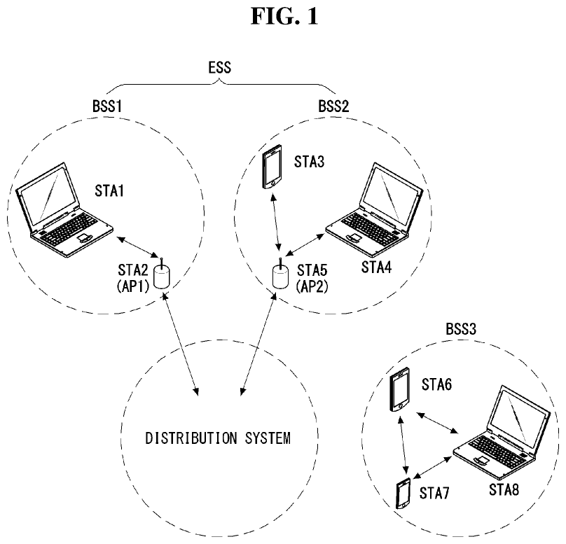

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

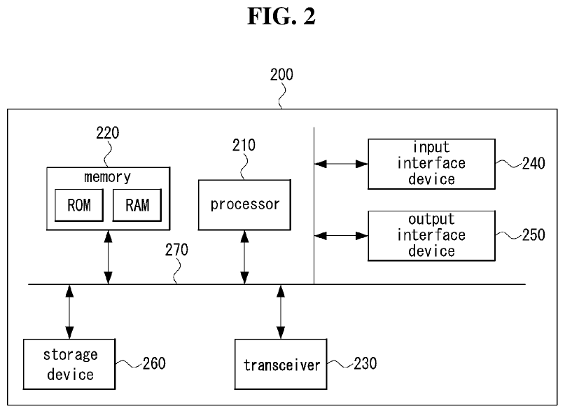

FIG. 2 is a block diagram illustrating a first exemplary embodiment of a communication node constituting a wireless LAN system.

Referring to FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

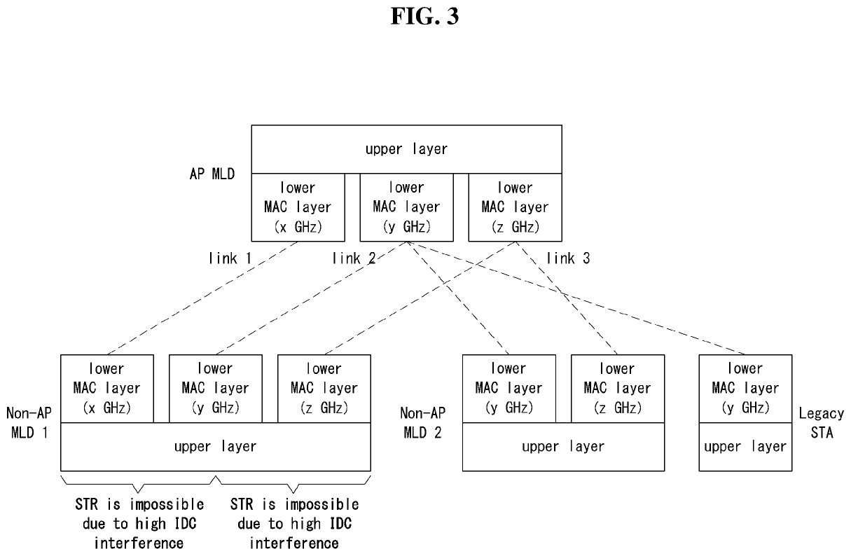

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD). The AP of the AP MLD may mean an AP affiliated with the AP MLD. The STA of the STA MLD may mean a STA affiliated with the STA MLD.

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as a receiver address(es), and may generate and transmit frame(s) including the receiver address(es).

Meanwhile, an association procedure in a wireless LAN system may be performed as follows.

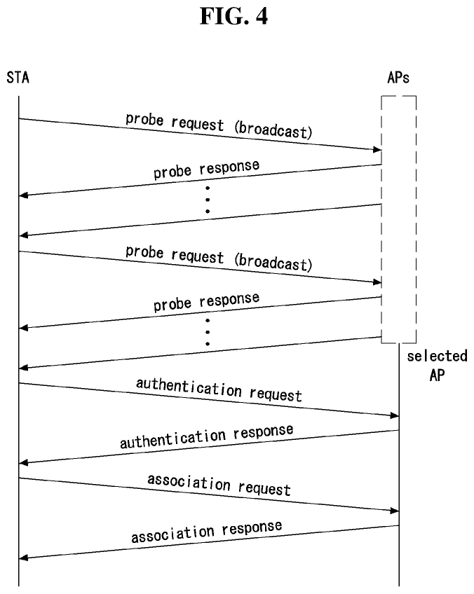

FIG. 4 is a sequence chart illustrating an association procedure of a station in a wireless LAN system.

Referring to FIG. 4, an association procedure of a STA in an infrastructure BSS may generally be divided into a probe step of detecting AP(s), an authentication step with detected AP(s), and an association step with the authenticated AP(s). The STA may be a STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g., access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

The control frame may include an acknowledgment (ACK) frame, block ACK request (BAR) frame, block ACK (BA) frame, power saving (PS)-Poll frame, request-to-send (RTS) frame, clear-to-send (CTS) frame, and the like. The data frame may be classified into a quality of service (QOS) data frame and a non-QoS data frame. The QoS data frame may refer to a data frame for which transmission according to a QoS is required, and the non-QoS data frame may indicate a data frame for which transmission according to a QoS is not required. The QoS data frame may include a QoS Null frame, and the QoS Null frame may not include a payload.

Meanwhile, in a wireless LAN system, a communication node (e.g., access point or station) may operate based on the EDCA scheme.

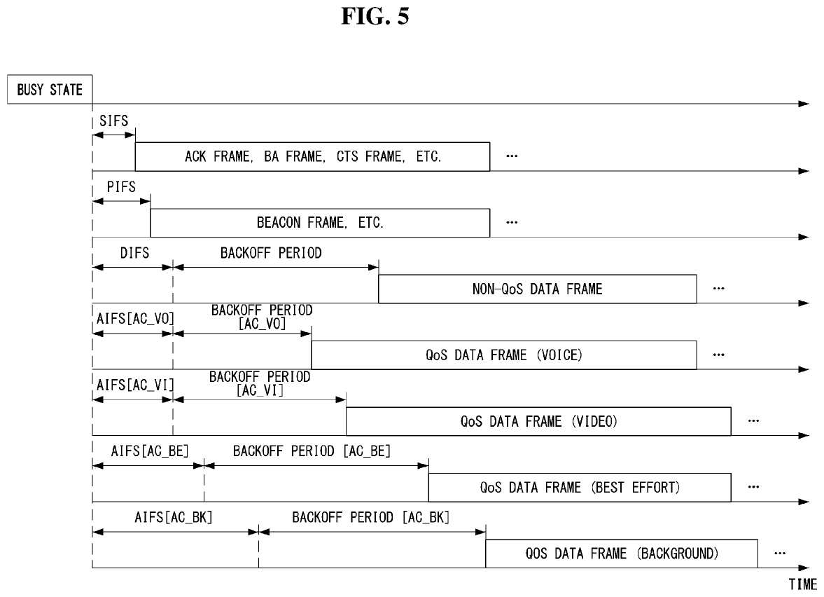

FIG. 5 is a timing diagram illustrating a first exemplary embodiment of an operation method of a communication node based on EDCA.

Referring to FIG. 5, a communication node desiring to transmit a control frame (or a management frame) may perform a channel state monitoring operation (e.g., carrier sensing operation) during a predetermined period (e.g., short interframe space (SIFS) or PCF IFS (PIFS)), and when the channel state is determined to be idle during the predetermined period (e.g., SIFS or PIFS), the communication node may transmit the control frame (or the management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g., SIFS or PIFS), the communication node may not transmit the control frame (or the management frame). Here, the carrier sensing operation may refer to a clear channel assessment (CCA) operation.

A communication node desiring to transmit a non-QoS data frame may perform a channel state monitoring operation (e.g., carrier sensing operation) during DCF IFS (DIFS), and when the channel state is determined to be idle during the DIFS, the communication node may perform a random backoff procedure. For example, the communication node may select a backoff value (e.g., a backoff counter) within a contention window according to the random backoff procedure and may perform a channel state monitoring operation (e.g., carrier sensing operation) during a period corresponding to the selected backoff value (hereinafter, referred to as ‘backoff period’). The communication node may transmit the non-QoS data frame when the channel state is determined to be idle in the backoff period.

A communication node desiring to transmit a QoS data frame may perform a channel state monitoring operation (e.g., carrier sensing operation) during an arbitration IFS (AIFS), and when the channel state is determined to be idle during the AIFS, the communication node may perform a random backoff procedure. The AIFS may be configured according to an access category (AC) of a data unit (e.g., protocol data unit (PDU)) included in the QoS data frame. The AC of the data unit may be as shown in Table 1 below.

TABLE 1

| Priority | AC | Description |
|---|---|---|
| Lowest | AC_BK | Background |
| | AC_BE | Best effort |
| | AC_VI | Video |
| Highest | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE.

In the random backoff procedure, the communication node may select a backoff value (e.g., a backoff counter) within a contention window according to the AC of the QoS data frame. The contention window according to the AC may be as shown in Table 2 below. CWₘᵢₙ may indicate a minimum value of the contention window, CWₘₐₓ may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g., carrier sensing operation) in the backoff period and may transmit the QoS data frame when the channel state is determined to be idle in the backoff period.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

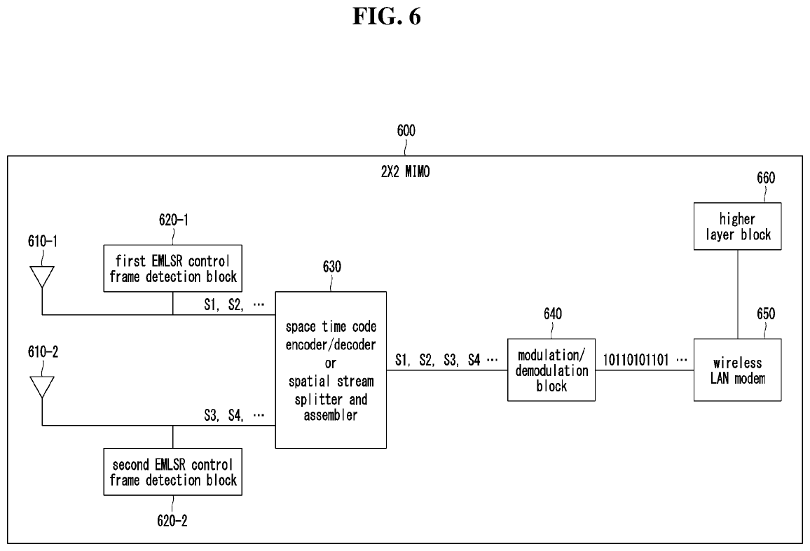

FIG. 6 is a block diagram illustrating a first exemplary embodiment of an enhanced multi-link single radio (EMLSR) device in a wireless LAN.

Referring to FIG. 6, an EMLSR device 600 may be an MLD supporting MLSR operations and/or EMLSR operations. The EMLSR device 600 may be referred to as an MLSR device. An EMLSR STA (or MLSR STA) may be a STA supporting MLSR operations and/or EMLSR operations, and an EMLSR AP (or MLSR AP) may be an AP supporting MLSR operations and/or EMLSR operations. The MLSR operation may mean an MLSR mode, and the EMLSR operation may mean an EMLSR mode. The EMLSR device 600 may include antennas 610-1 and 610-2, EMLSR control message detection blocks 620-1 and 620-2, a spatial stream processing block 630, a modulation/demodulation block 640, a wireless LAN modem 650, and/or a higher layer block 660. In exemplary embodiments, a spatial stream may be referred to as ‘SS’.

The EMLSR device 600 may include the plurality of antennas 610-1 and 610-2. The first antenna 610-1 may be used for a sensing operation and/or reception operation of signals in a first link. The second antenna 610-2 may be used for a sensing operation and/or reception operation of signals in a second link. A frequency at which the first link operates may be different from a frequency at which the second link operates. The sensing operation and/or reception operation performed by the first antenna and/or the second antenna may be referred to as a listening operation. In order to simultaneously receive spatial stream signals, the first antenna 610-1 and the second antenna 610-2 may perform a sensing operation and/or reception operation of signals in one of the first link and the second link. Among the plurality of antennas 610-1 and 610-2 included in the EMLSR device 600, one antenna may be a primary antenna, and the remaining antenna(s) may be secondary antenna(s). The primary antenna and the secondary antenna(s) may be preconfigured. Alternatively, the primary antenna and the secondary antenna(s) may be configured in a negotiation procedure between the EMLSR device 600 and another device (e.g., AP MLD supporting EMLSR operations). Alternatively, an antenna performing a listening operation in a link having a low number (e.g., low index) may be configured as the primary antenna, and the remaining antenna(s) may be configured as the secondary antenna(s).

The first EMLSR control frame detection block 620-1 may be connected to or cooperate with the first antenna 610-1, and the second EMLSR control frame detection block 620-2 may be connected to or cooperate with the second antenna 610-2. Electromagnetic waves (e.g., signals) detected by the antennas 610-1 and 610-2 may be input to the EMLSR control frame detection blocks 620-1 and 620-2. The EMLSR control frame detection blocks 620-1 and 620-2 may determine whether the electromagnetic wave (e.g., signal) corresponds to a specific control frame (e.g., initial control frame). The EMLSR control frame detection blocks 620-1 and 620-2 may support only a predefined modulation and coding scheme (MCS) and may identify only a predefined control frame format. The format of the predefined control frame (e.g., specific control frame) may be a request to send (RTS) frame and/or a multi-user (MU)-RTS trigger frame.

When a specific control frame is detected in the EMLSR control frame detection blocks 620-1 and 620-2, the EMLSR device 600 may perform a reception operation for receiving data through multiple streams by simultaneously using as many as spatial streams as the number of spatial streams (e.g., the number of antennas) supported by the EMLSR device 600. In order to perform the reception operation for simultaneously receiving multiple spatial streams, a clear to send (CTS) frame may be transmitted through the first antenna 610-1 after a short interframe space (SIFS) from a time point of detecting the specific control frame in the first link, and the second antenna 610-2 operating in the second link in which the specific control frame is not detected may switch to the first link and operate in the first link. That is, a reception (RX) radio chain may be switched to operate in the first link. The reception radio chain may mean a radio chain in the present disclosure. In addition, the radio chain may mean a reception radio chain or a reception chain in the present disclosure. The radio chain may mean a radio frequency (RF) chain. Switching of an operating link (e.g., switching of the radio chain) of the second antenna 610-2 may start after the time point of detecting the specific control frame in the first link, and may be completed until a SIFS elapses after transmitting the CTS frame after a SIFS elapses. Thereafter, the multiple spatial streams (e.g., two spatial streams) may be received through the multiple antennas 610-1 and 610-2. The operation of receiving the MU-RTS trigger frame and switching the radio chain to receive the multiple spatial streams may be referred to as ‘EMLSR operation’.

When a signal is detected from one of the plurality of antennas 610-1 and 610-2, and the EMLSR control frame detection blocks 620-1 and 620-2 determine that the signal does not correspond to the specific control frame, the signal may be transferred to the modulation/demodulation block 640 without going through the spatial stream processing block 630. In this case, the one antenna that detects the signal may be the primary antenna.

When the specific control frame is detected in the EMLSR control frame detection blocks 620-1 and 620-2, and the reception procedure for the multiple spatial streams is performed, the spatial stream processing block 630 may perform a rearrangement operation for signals (e.g., symbols) received from the plurality of antennas 610-1 and 610-2. When a space-time code is used, a single symbol may be generated into a plurality of symbols by a coding operation, and the plurality of symbols may be transmitted. The space-time code may be an Alamouti code. The spatial stream processing block 630 may perform an operation of restoring the redundant symbols into the single symbol in a decoding procedure.

Output symbols of the spatial stream processing block 630 may be input to the modulation/demodulation block 640. The modulation/demodulation block 640 may generate bits by performing a demodulation operation on the symbols. The modulation/demodulation block 640 may perform a channel coding operation and/or a channel decoding operation. Output bits of the modulation/demodulation block 640 may be transferred to the wireless LAN modem 650. The wireless LAN modem 650 may perform a medium access control (MAC) operation defined in the IEEE 802.11 standards. An output of the wireless LAN modem 650 may be transferred to the higher layer block 660. The higher layer block 660 may perform higher layer operations defined in the IEEE 802.11 standards. A series of operations performed after the specific control frame is detected by the EMLSR control frame detection block may be operations performed during the EMLSR operation. In the EMLSR device 600, a transmission operation may be performed in the reverse order of the above-described reception operation. The above-described antenna may be a radio frequency chain (RF chain) that is a transmission and reception block including the antenna. The RF chain may be a hardware or/and logical structure including both a transmission (TX) chain and a reception (Rx) chain.

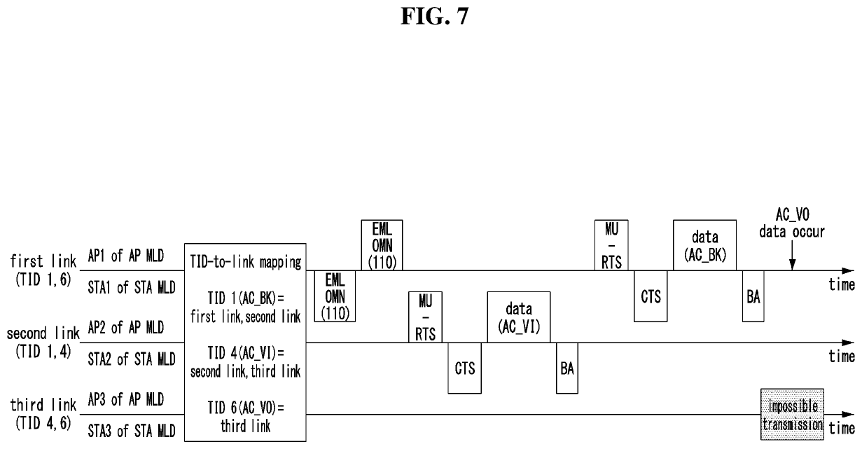

FIG. 7 is a timing diagram illustrating a first exemplary embodiment of a communication method in a device supporting an EMLSR mode.

Referring to FIG. 7, an AP MLD and/or a STA MLD may support the EMLSR mode. The AP MLD may mean an EMLSR AP MLD, and the STA MLD may mean an EMLSR STA MLD. The STA MLD may receive a beacon frame from the AP MLD in one link (e.g., first link) of a multi-link. When the beacon frame is received, the STA MLD may perform an association procedure with the AP MLD in the one link (e.g., first link) of the multi-link. In the association procedure, the STA MLD may transmit an association request frame. The association request frame may include multi-link configuration information. The multi-link configuration information may include a link information (i.e., Link Info) field, and the link information field may include information on STA(s) (e.g., per-STA profile(s)) affiliated with the STA MLD. A STA may be in charge of each link. The link information field may include as many per-STA profiles as the number of links.

When the STA MLD supports three links, the link information field includes three per-STA profiles (e.g., per-STA profile #1, per-STA profile #2, and per-STA profile #3). The per-STA profile may include at least one of an identifier of a link for which the STA is responsible, a MAC address of the STA, or capability information of the STA. The MAC address of the STA may be omitted from the per-STA profile.

The AP MLD may receive the association request frame from the STA MLD, and may transmit an association response frame to the STA MLD in response to the association request frame. The association response frame may include a link information field. The STA MLD may receive the association response frame from the AP MLD. When the association response frame including the link information field is received, it may be determined that multi-link configuration is completed. The configured multi-link may be referred to as enabled links. In the exemplary embodiment of FIG. 7, each of the first link, the second link, and the third link may be an enabled link.

The association request frame may include a traffic identifier (TID)-to-link mapping element. The TID-to-link mapping element may indicate a link in which data (e.g., traffic, packet, frame) having a specific TID is transmitted. If a TID-to-link mapping negotiation supported indicator included in the beacon frame transmitted by the AP MLD is activated (e.g., enabled), the association request frame may include the TID-to-link mapping element.

The TID-to-link mapping element may include an indicator indicating whether to use default link mapping. When it is indicated that the default link mapping is not used, a link mapping bitmap for each TID may be included in the TID-to-link mapping element. The default link mapping may mean that all TIDs are mapped to all links. Therefore, when the default link mapping is used, data for all TIDs can be transmitted in each link.

Eight TIDs (e.g., TID 0 to TID 7) may exist. One TID may be mapped to up to 16 links. A 16-bit bitmap may be configured for each TID. If a bitmap of the TID 0 is set to 1110 0000 0000 0000 (e.g., if the TID 0 is mapped to the bitmap), this may mean that data with the TID 0 can be transmitted in the first link, the second link, and the third link. The TID-to-link mapping may be configured through exchange of separate management message(s). The separate management message(s) may include a TID-to-link mapping request frame and/or a TID-to-link mapping response frame. Alternatively, the TID-to-link mapping may be configured by a broadcast TID-to-link mapping element included in beacon frame(s) transmitted by one or more APs of the AP MLD.

The number of links capable of EMLSR operations of the STA MLD may be limited depending on the number of antennas (e.g., 610-1 and 610-2 shown in FIG. 6) or the number of EMLSR control frame detection blocks (e.g., 620-1 and 620-2 shown in FIG. 6). The number of links capable of EMLSR operations may be smaller than the number of enable links.

The STA MLD may transmit an EML operating mode notification (OMN) frame using one of the enable links to configure links in which the EMLSR operation is to be performed. The EML OMN frame may include an EML control field. The EML control field may include a 16-bit EMLSR link bitmap. A bit set to a first value (e.g., 0) in the EMLSR link bitmap may indicate a link in which the EMLSR operation (e.g., simultaneous reception standby operation) is not performed. A bit set to a second value (e.g., 1) in the EMLSR link bitmap may indicate a link in which the EMLSR operation (e.g., simultaneous reception standby operation) is performed.

In the exemplary embodiment of FIG. 7, the EMLSR link bitmap included in the EML OMN frame transmitted by the STA MLD (e.g., STA1) may be set to 110. That is, the STA MLD may request to configure the first link and the second link as simultaneous reception standby links by transmitting the EML OMN frame. The STA MLD may operate in a simultaneous reception standby state in the simultaneous reception standby links. The AP MLD may receive the EML OMN frame from the STA MLD, and based on the EMLSR link bitmap (i.e., 110) included in the EML OMN frame, the AP MLD may identify the simultaneous reception standby links (i.e., the first link and the second link) requested by the STA MLD. In order to indicate that the first link and the second link are configured as the simultaneous reception standby links (e.g., in order to confirm that the first link and the second link are the simultaneous reception standby links), the AP MLD may transmit an EML OML frame including an EMLSR link bitmap set to 110 to the STA MLD. The STA MLD may receive the EML OMN frame from the AP MLD, and based on the EMLSR link bitmap (i.e., 110) included in the EML OMN frame, the STA MLD may identify that the first link and the second link are configured as the simultaneous reception standby links (e.g., EMLSR links).

Thereafter, the STA MLD may wait for reception of a specific control message (e.g., MU-RTS frame) in the first link and the second link. The control message may mean a control frame. A specific control message may be an initial control frame. The AP MLD may transmit an MU-RTS frame in the second link. The STA MLD may receive the MU-RTS frame in the second link, and the antenna or RF chain in a reception standby state in the first link may be switched to the second link during reception of the MU-RTS frame. The STA MLD may transmit a CTS frame, which is a response to the MU-RTS frame, in the second link after a SIFS elapses from an end time point of transmission of the MU-RTS frame. Alternatively, the operation of switching the antenna or RF chain to the second link may be performed after transmission of the CTS frame in the second link. The STA MLD may wait for reception of data using antennas in the second link.

That the STA MLD can simultaneously wait for reception in two links may mean that the STA MLD can receive two spatial streams. Accordingly, the AP MLD may transmit a data frame using two spatial streams after a SIFS elapses from the time point of receiving the CTS frame. The STA MLD may receive the data frame from the AP MLD in the second link, and may transmit a reception response frame for the data frame to the AP MLD in the second link. The reception response frame may be an acknowledgment (ACK) frame or a block ACK (BA) frame.

After the reception operation of the data frame is completed (e.g., after the reception response frame for the data frame is transmitted), the STA MLD may perform a link switching operation of one antenna to wait for reception in the first link. That is, the STA MLD may wait for reception in the first link and the second link. The AP MLD may transmit an MU-RTS frame in the first link, and the STA MLD may receive the MU-RTS frame from the AP MLD in the first link. In this case, identically to the above-described scheme, the STA MLD may perform a reception operation through two spatial streams in the first link.

AC_VO data to be transmitted to the STA MLD may occur in the AP MLD. Since the TID 6 of the AC_VO data is mapped to the third link, and the third link is not a simultaneous reception standby link, the AP MLD may not be able to transmit the AC_VO data to the STA MLD.

The above-described antenna(s) may be RF chain(s) or reception chain(s) including the antenna(s). The chain may also be referred to as a module.

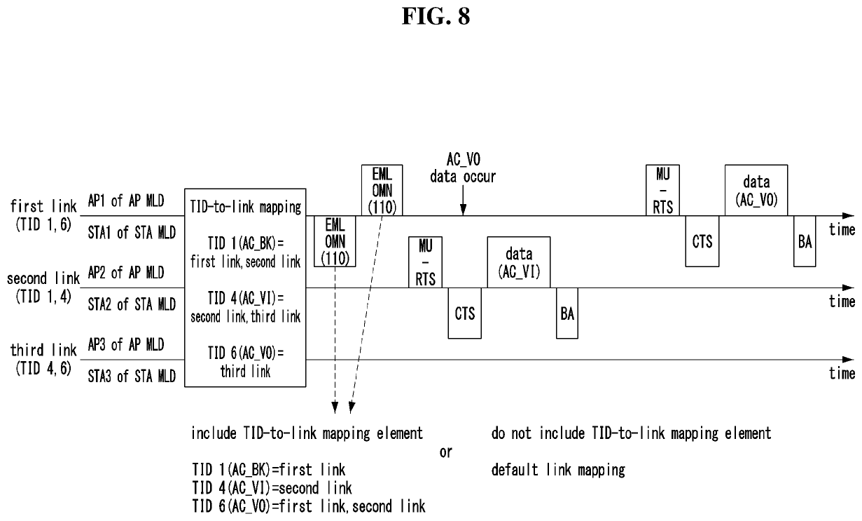

FIG. 8 is a timing diagram illustrating a second exemplary embodiment of a communication method in a device supporting an EMLSR mode.

Referring to FIG. 8, an AP MLD and/or a STA MLD may support the EMLSR mode. The AP MLD may mean an EMLSR AP MLD, and the STA MLD may mean an EMLSR STA MLD. The first link, the second link, and the third link may be enabled links. The STA MLD (e.g., STA1) may configure an EMLSR link bitmap set to 110 to request to configure the first link and the second link as simultaneous reception standby links, and transmit an EML OMN frame including the EMLSR link bitmap. The AP MLD may receive the EML OMN frame from the STA MLD, and based on the EMLSR link bitmap (i.e., 110) included in the EML OMN frame, the AP MLD may identify the simultaneous reception standby links (i.e., the first link and the second link) requested by the STA MLD. In order to indicate that the first link and the second link are configured as the simultaneous reception standby links (e.g., in order to confirm that the first link and the second link are the simultaneous reception standby links), the AP MLD may transmit, to the STA MLD, an EML OMN frame including an EMLSR link bitmap set to 1110. The STA MLD may receive the EML OMN frame from the AP MLD, and based on the EMLSR link bitmap (i.e., 110) included in the EML OMN frame, the STA MLD may identify that the first link and the second link are configured as the simultaneous reception standby links (e.g., EMLSR links).

Since the simultaneous reception standby links are the first link and the second link, reception of data having the TID 6 (e.g., AC_VO data) may be impossible in the third link. Therefore, a TID-to-link remapping operation may be performed in the procedure of transmitting and receiving the EML OMN frame. For example, the STA MLD and/or AP MLD may transmit the EML OMN frame including a TID-to-link mapping element. The TID-to-link mapping element may indicate that simultaneous reception standby links for all TIDs are the first link and the second link. The AP MLD may change the TID-to-link mapping requested by the STA MLD through the EML OMN frame. In this case, the AP MLD may change only the mapping for the simultaneous reception standby links requested by the STA MLD. Alternatively, since the AP MLD knows information on the TID-to-link mapping of the STA MLD, the AP MLD may transmit an EML OMN frame including TID-to-link mapping information in the procedure of transmitting and receiving the EML OMN frame with the STA MLD without a request of the STA MLD.

As another method for TID-to-link mapping, when the EML OMN frame is transmitted and received, a default link mapping may be used. If the EML OMN frame does not include the TID-to-link mapping element, the default link mapping may be used. In this case, all TIDs may be mapped to all links. If the default link mapping is used, data of all TIDs can be transmitted in any link.

After the procedure of exchanging EML OMN frames between the STA MLD and the AP MLD, the TID-to-link mapping may be changed by the AP MLD. When the TID-to-link mapping is modified by the AP and a TID that cannot be transmitted or received occurs, the AP MLD and the STA MLD may perform the above-described procedure again to reconfigure the TID-to-link mapping. Alternatively, the AP MLD may reconfigure the TID-to-link mapping by transmitting TID-to-link mapping information applied only to specific STA MLDs.

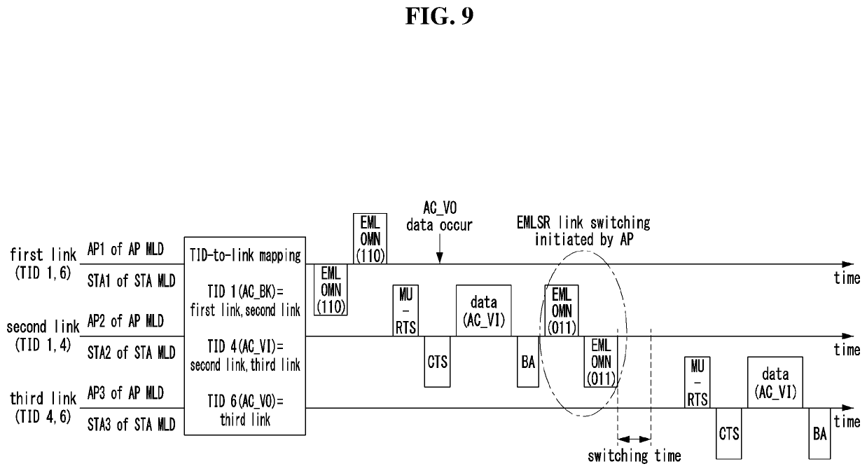

FIG. 9 is a timing diagram illustrating a third exemplary embodiment of a communication method in a device supporting an EMLSR mode.

Referring to FIG. 9, an AP MLD and/or a STA MLD may support the EMLSR mode. The AP MLD may mean an EMLSR AP MLD, and the STA MLD may mean an EMLSR STA MLD. The first link, the second link, and the third link may be enabled links. In the EMLSR procedure, if the AP MLD needs to transmit, to the STA MLD, data of a TID mapped to a link other than a link configured as a simultaneous reception standby link (e.g., EMLSR link), the AP MLD may transmit an EML OMN frame to the STA MLD to change the EMLSR link. Alternatively, when the TID-to-link mapping information is changed by the AP, and the AP MLD needs to transmit, to the STA MLD, data of a TID mapped to a link other than a link configured as a simultaneous reception standby link (e.g., EMLSR link), or when the STA MLD cannot transmit a specific TID due to the TID-to-link mapping changed by the AP MLD, the AP MLD may transmit an EML OMN frame to the STA MLD to change the EMLSR link.

In the EMLSR procedure, the AP MLD may perform a data transmission procedure starting with transmission of an MU-RTS frame (e.g., specific control frame, initial control frame). Therefore, for transmission of the EML OMN frame, the AP MLD may transmit the MU-RTS frame, and the STA MLD may transmit a CTS frame in a link where the MU-RTS frame is received after receiving the MU-RTS frame. The AP MLD may receive the CTS frame from the STA MLD, and may transmit an EML OMN frame after a SIFS elapses from the time point of receiving the CTS frame. In this case, the AP MLD may transmit the EML OMN frame using spatial streams (e.g., two spatial streams) supported by the EMLSR STA MLD. The EML OMN frame transmitted from the AP MLD to the STA MLD may indicate link(s) in which the STA MLD needs to perform the EMLSR operation. For example, the AP MLD may indicate that the STA MLD needs to perform the EMLSR operation (e.g., perform a standby operation for a specific control frame) in the second link and the third link using a link bitmap included in the EML OMN frame. The STA MLD may transmit an EML OMN frame to the AP MLD in response to the EML OMN frame of the AP MLD. A link bitmap included in the EML OMN frame of the STA MLD may indicate execution of the EMLSR operation in the second link and the third link.

Alternatively, the AP MLD may transmit the EML OMN frame without transmitting the MU-RTS frame. That is, the AP MLD may transmit the EML OMN frame in a link through which the STA MLD can receive the frame without initiation by the MU-RTS frame. The link through which the STA MLD can receive the frame without initiation by the MU-RTS frame may be the link (e.g., first link) in which the association procedure between the initial AP MLD and the STA MLD has been performed. Alternatively, the link through which the STA MLD can receive the frame without initiation by the MU-RTS frame may be the link (e.g., second link) through which the STA MLD last received a data frame. In this case, the AP MLD may transmit the EML OMN frame without transmitting the MU-RTS frame. In this case, the AP may transmit the EML OMN frame using one spatial stream.

Alternatively, the AP MLD may perform a transmission operation including transmission of the EML OMN frame within a TXOP in which downlink transmission for the STA MLD is performed. For example, the AP MLD may initiate a TXOP starting with a specific control frame, MU-RTS frame, in the second link. The AP MLD may transmit the EML OMN frame to the STA MLD in the TXOP within (SIFS+aSlotTime+aRxPHYStartDelay) after transmission of data and reception of a BA frame are completed. The TXOP configured by the AP MLD for transmission to the STA MLD may be configured to be long enough in consideration of a transmission time and IFS times of the EML OMN frame.

The above-described EML OMN frame transmitted from the AP MLD to the STA MLD may be a broadcast frame. For example, a receiver address (RA) of the EML OMN frame may be a broadcast address. Alternatively, the EML OMN frame may be a groupcast frame. For example, an RA of the EML OMN frame may be a group address indicating a group including EMLSR STA MLDs. The EML OMN frame having the RA configured as a broadcast address or a group cast address may be applied to multiple EMLSR STA MLDs. The EMLSR STAs may transmit an EML OMN frame, which is a response frame, to the AP MLD. Alternatively, the EMLSR STAs may not transmit an EML OMN frame, which is a response frame, to the AP MLD.

Due to the above-described EML OMN exchange process, a delay time in which the EMLSR STA MLD changes the EMLSR link (e.g., simultaneous reception standby link) may occur. The delay time may be a switching time. The switching time may be referred to as an EMLSR transition delay. The STA MLD may not be able to perform a transmission operation and a reception operation in a specific link or all links during the switching time. The AP MLD may perform transmission for the STA MLD considering the switching time of the STA MLD.

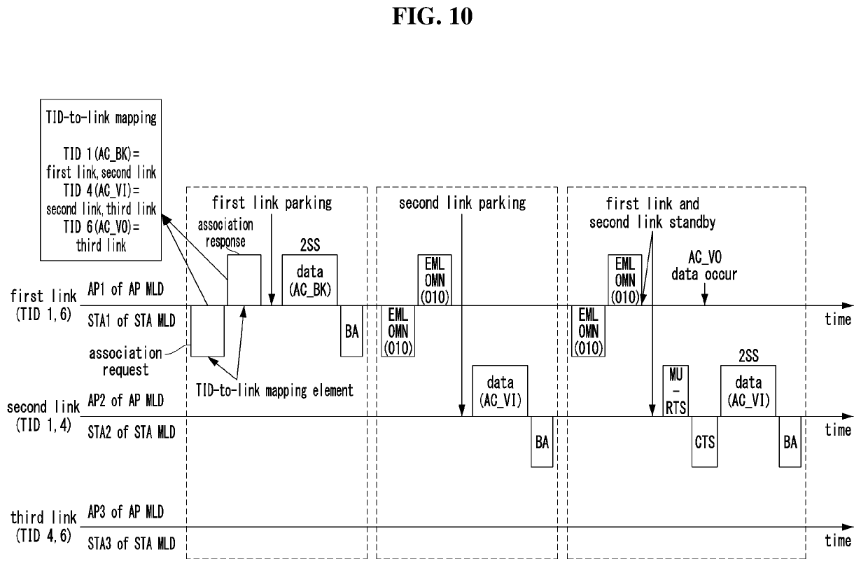

FIG. 10 is a timing diagram illustrating a fourth exemplary embodiment of a communication method in a device supporting an EMLSR mode.

Referring to FIG. 10, an AP MLD and/or a STA MLD may support the EMLSR mode. The AP MLD may mean an EMLSR AP MLD, and the STA MLD may mean an EMLSR STA MLD. The first link, the second link, and the third link may be enabled links. A link through which the STA MLD can receive a frame without initiation by an MU-RTS frame may be indicated (e.g., configured) by the STA MLD. This operation may refer to a single link operation rather than a multi-link operation. Configuration of a single link may be referred to as a link parking. First link parking (e.g., link 1 parking) may mean that the first link is configured as a single link. Second link parking (e.g., link 2 parking) may mean that the second link is configured as a single link. In a parked link, the STA MLD may receive a frame using spatial stream(s) corresponding to the number of supported radios without initiation by an MU-RTS frame.

In a first link parking method, the link (e.g., first link) in which an association procedure between the STA MLD and the AP MLD has been performed may be implicitly configured as a parked link. The STA MLD supporting two radios (e.g., reception chains or RF chains) may receive a frame using two spatial streams in the parked first link.

In a second link parking method, an EML OMN frame may indicate one link (e.g., second link) as a parked link. For example, in the exemplary embodiment of FIG. 10, the STA MLD may transmit an EML OMN frame including an EMLSR link bitmap set to 010. That is, the EML OMN frame may request to configure the second link as a simultaneous reception standby link (e.g., EMLSR link). Since only one link (i.e., second link) is configured as the simultaneous reception standby link, the second link may be a parked link. Accordingly, the STA MLD may perform a reception operation using multiple spatial streams (e.g., two spatial streams) in the second link without initiation of a transmission/reception procedure by an MU-RTS frame.

In order to release the link parking (i.e., change the single link operation to the EMLSR operation), the STA MLD and/or AP MLD may configure an EMLSR link bitmap to indicate two or more links, and transmit an EML OMN frame including the EMLSR link bitmap. That is, the EML OMN frame may request to configure two or more links as simultaneous reception standby links. When the transmission/reception procedure of the EML OMN frame requesting to configure two or more links as simultaneous reception standby links is completed, the STA MLD may wait for reception of an MU-RTS frame (e.g., initial control frame) initiating a data transmission procedure in the two or more links indicated by the EML OMN frame.

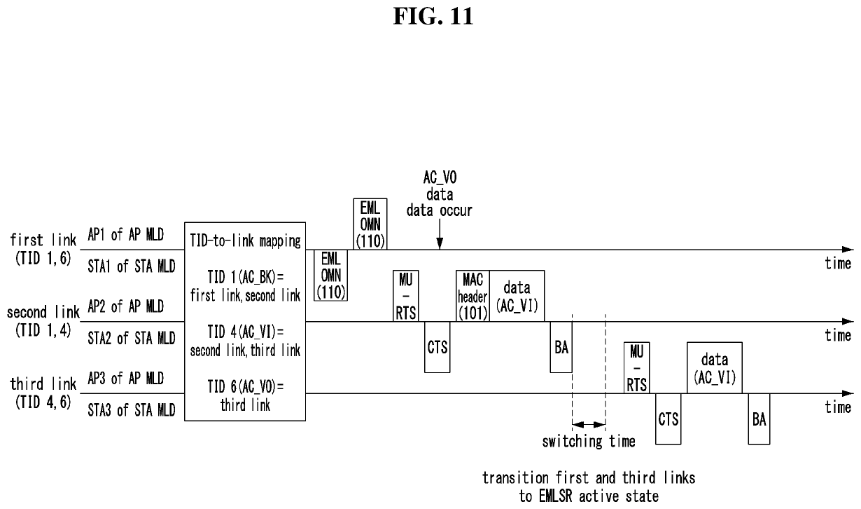

FIG. 11 is a timing diagram illustrating a fifth exemplary embodiment of a communication method in a device supporting an EMLSR mode.

Referring to FIG. 11, an AP MLD and/or a STA MLD may support the EMLSR mode. The AP MLD may mean an EMLSR AP MLD, and the STA MLD may mean an EMLSR STA MLD. The first link, the second link, and the third link may be enabled links. In the EMLSR procedure, if the AP MLD needs to transmit, to the STA MLD, data of a TID mapped to a link other than a link configured as a simultaneous reception standby link (e.g., EMLSR link), the simultaneous reception standby link may be reconfigured using a frame transmitted in the simultaneous reception standby link. The AP MLD (e.g., AP2) may generate a MAC header including EML OMN control information in form of an A-control, and may transmit a data frame including the MAC header in the second link.

The EML OMN control information may be a 16-bit EMLSR link bitmap. Identically to the EML OMN frame, links indicated by the EMLSR link bitmap included in the MAC header of the data frame may be configured as simultaneous reception standby links. A frame transmission procedure initiated by an MU-RTS frame may be performed in the simultaneous reception standby link. In the exemplary embodiment of FIG. 11, when the EMLSR link bitmap included in the MAC header of the data frame is set to 101, the first link and the second link may be configured as the simultaneous reception standby links.

The STA MLD may receive the data frame from the AP MLD, and may identify the EMLSR link bitmap (i.e., 101) included in the MAC header of the data frame. If the STA MLD fails to designate the third link as the simultaneous reception standby link, the STA MLD may transmit an EML OMN frame together with a reception response frame (e.g., BA frame). In this case, the STA MLD may transmit an aggregated (A)-MAC layer protocol data unit (MPDU) including the reception response frame and the EML OMN frame. Alternatively, the STA MLD may separately transmit the BA frame and the EML OMN frame at a SIFS interval. The EML OMN frame transmitted by the STA MLD may include a TID-to-link mapping element. The AP MLD may receive the EML OMN frame from the STA MLD and may identify the TID-to-link mapping element included in the EML OMN frame. The AP MLD may approve the request of the STA MLD by transmitting an EML OMN frame.

Due to the above-described EML OMN exchange process, a delay time in which the EMLSR STA MLD changes the EMLSR link (e.g., simultaneous reception standby link) may occur. The delay time may be a switching time. The switching time may be referred to as an EMLSR transition delay. The STA MLD may not be able to perform a transmission operation and a reception operation in a specific link or all links during the switching time. The AP MLD may perform transmission for the STA MLD considering the switching time of the STA MLD.

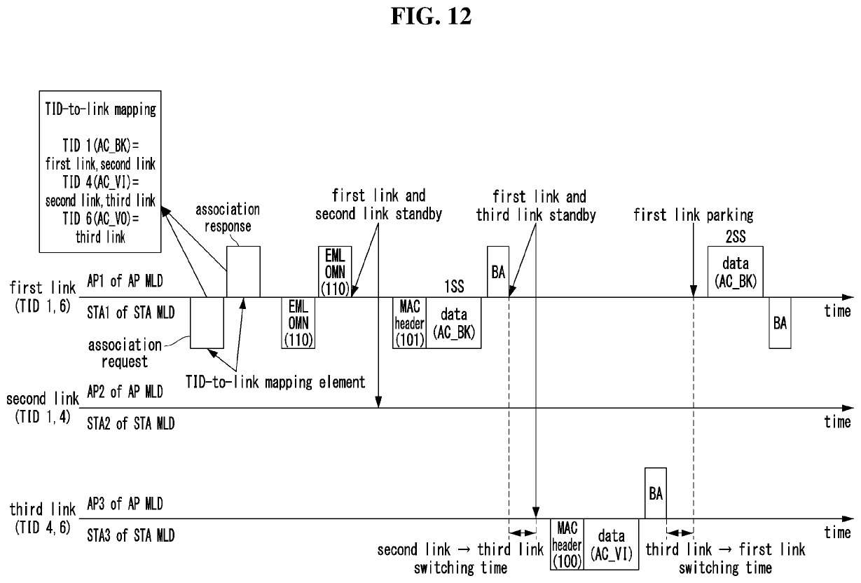

FIG. 12 is a timing diagram illustrating a sixth exemplary embodiment of a communication method in a device supporting an EMLSR mode.

Referring to FIG. 12, an AP MLD and/or a STA MLD may support the EMLSR mode. The AP MLD may mean an EMLSR AP MLD, and the STA MLD may mean an EMLSR STA MLD. The first link, the second link, and the third link may be enabled links. The STA MLD may generate a MAC header including EML OMN control information in form of an A-control, and may change a simultaneous reception standby link by transmitting a data frame including the MAC header. When an EMLSR link bitmap included in the EML OMN control information is set to 101, the first link and the third link may be configured as simultaneous reception standby links after a time point of transmitting the data frame.

The AP MLD may receive the data frame from the STA MLD, and may identify the EMLSR link bitmap (i.e., 101) included in the MAC header of the data frame. If the AP MLD fails to designate the third link as the simultaneous reception standby link, the AP MLD may transmit an EML OMN frame together with a reception response frame (e.g., BA frame). In this case, the AP MLD may transmit an A-MPDU including the reception response frame and the EML OMN frame. Alternatively, the STA MLD may separately transmit the BA frame and the EML OMN frame at a SIFS interval. The EML OMN frame transmitted by the AP MLD may include a TID-to-link mapping element. The STA MLD may receive the EML OMN frame from the AP MLD and may identify the TID-to-link mapping element included in the EML OMN frame. The STA MLD may confirm the simultaneous reception standby link configured by the AP by transmitting an EML OMN frame.

After a time required for link switching from a time point of receiving the reception response frame for the data frame including the EMLSR link bitmap (i.e., 101), a data transmission/reception procedure may be performed in link(s) indicated by the data frame. The operating link may be switched from the first link to the third link. Thereafter, the STA MLD may transmit a data frame including the EML OMN control information. The EML OMN control information may include an EMLSR link bitmap set to 100. When a data frame including the EML OMN control information (i.e., 100) is transmitted, link parking for the first link may be performed.

After a time required for link switching from a time point of receiving the reception response frame for the data frame including the EMLSR link bitmap (i.e., 100), a data frame transmission/reception procedure may be performed in the first link indicated by the data frame. In the data frame transmission/reception procedure, as many spatial streams as the number of radios supported by the AP MLD and/or STA MLD may be used.

The time required for link switching or the link switching time described above may be referred to as EMLSR transition delay. The STA MLD may not be able to perform transmission and reception operations in a specific link or all links during the switching time.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first device, comprising:
performing a configuration operation of simultaneous reception standby links with a second device;
when a first link and a second link are configured as the simultaneous reception standby links, simultaneously performing reception standby operations in the first link and the second link;
receiving a control frame from the second device in the first link among the first link and the second link; and
receiving a data frame from the second device in the first link where the control frame is received.

2. The method according to claim 1, wherein the performing of the configuration operation comprises:
transmitting, to the second device, a first frame including a bitmap indicating the simultaneous reception standby links; and
receiving a second frame including the bitmap from the second device.

3. The method according to claim 1, further comprising, before performing the configuration operation, performing a traffic identifier (TID)-to-link mapping operation with the second device, wherein the first frame received in the first link has a first TID mapped to the first link.

4. The method according to claim 1, wherein a TID-to-link remapping operation is performed in the configuration operation, or a default link mapping is configured in the configuration operation.

5. The method according to claim 4, wherein the first frame is indicated to be transmittable and receivable in the first link by the TID-to-link remapping operation or the default link mapping.

6. The method according to claim 1, wherein the control frame is a multi-user (MU)-request to send (RTS) frame, a clear to send (CTS) frame, which is a response frame to the MU-RTS frame, is transmitted to the second device, and the data frame is received after transmission of the CTS frame.

7. The method according to claim 1, wherein the data frame includes reconfiguration information of the simultaneous reception standby links, and simultaneous reception standby links indicated by the reconfiguration information are different from the simultaneous reception standby links according to the configuration operation.

8. The method according to claim 7, further comprising:
transmitting, to the second device and in the first link, a reception response frame for the data frame; and
performing a reception standby operation simultaneously in the simultaneous reception standby links indicated by the reconfiguration information after transmission of the reception response frame.

9. A method of a second device, comprising:
performing a configuration operation of simultaneous reception standby links with a first device;
transmitting a control frame to the first device in the first link among the first link and the second link configured as the simultaneous receptions standby links; and
transmitting a data frame to the first device in the first link where the control frame is transmitted,
wherein a simultaneous reception standby operation of the first device is simultaneously performed in the simultaneous reception standby links.

10. The method according to claim 9, wherein the performing of the configuration operation comprises:
transmitting, to the first device, a first frame including a bitmap indicating the simultaneous reception standby links; and
receiving a second frame including the bitmap from the first device.

11. The method according to claim 9, further comprising, before performing the configuration operation, performing a traffic identifier (TID)-to-link mapping operation with the first device, wherein the first frame transmitted in the first link has a first TID mapped to the first link.

12. The method according to claim 9, wherein a TID-to-link remapping operation is performed in the configuration operation, or a default link mapping is configured in the configuration operation.

13. The method according to claim 12, wherein the first frame is indicated to be transmittable and receivable in the first link by the TID-to-link remapping operation or the default link mapping.

14. The method according to claim 9, wherein the data frame includes reconfiguration information of the simultaneous reception standby links, and simultaneous reception standby links indicated by the reconfiguration information are different from the simultaneous reception standby links according to the configuration operation.

15. The method according to claim 14, wherein after receiving the reception response frame for the data frame, the reception standby operation of the first device is simultaneously performed in the simultaneous reception standby links indicated by the reconfiguration information.

16. A first device comprising a processor, wherein the processor causes the first device to perform:
performing a configuration operation of simultaneous reception standby links with a second device;
when a first link and a second link are configured as the simultaneous reception standby links, simultaneously performing reception standby operations in the first link and the second link;
receiving a control frame from the second device in the first link among the first link and the second link; and
receiving a data frame from the second device in the first link where the control frame is received.

17. The first device according to claim 16, wherein in the performing of the configuration operation, the processor further causes the first device to perform:
transmitting, to the first device, a first frame including a bitmap indicating the simultaneous reception standby links; and
receiving a second frame including the bitmap from the first device.

18. The first device according to claim 16, wherein the processor further causes the first device to perform: performing a traffic identifier (TID)-to-link mapping operation with the second device before performing the configuration operation, wherein the first frame received in the first link has a first TID mapped to the first link.

19. The first device according to claim 16, wherein a TID-to-link remapping operation is performed in the configuration operation, or a default link mapping is configured in the configuration operation, and the first frame is indicated to be transmittable and receivable in the first link by the TID-to-link remapping operation or the default link mapping.

20. The first device according to claim 16, wherein the processor further causes the first device to perform:
transmitting, to the second device and in the first link, a reception response frame for the data frame; and
performing a reception standby operation simultaneously in simultaneous reception standby links indicated by reconfiguration information of the simultaneous reception standby links after transmission of the reception response frame, the reconfiguration information being included in the data frame,
wherein the simultaneous reception standby links indicated by the reconfiguration information are different from the simultaneous reception standby link according to the configuration operation.
